(19) United States
(12) Patent Application Publication
(10) Pub. No.: US 2012/0062990 A1
(43) Pub. Date: Mar. 15, 2012

(54) THREE-DIMENSIONAL IMAGE DISPLAY APPARATUS AND IMAGE DISPLAY DEVICE

(75) Inventor: Yoshiki Okamoto, Kanagawa (JP)

(73) Assignee: SONY CORPORATION, Tokyo (JP)

(21) Appl. No.: 13/223,414

(22) Filed: Sep. 1, 2011

(30) Foreign Application Priority Data
Sep. 10, 2010 (JP) 2010-203474

(51) Int. Cl. G02B 27/22

(52) U.S. Cl. 359/463; 359/462

(57) ABSTRACT

Disclosed herein is a three-dimensional image display apparatus including: an image display device in which a plurality of pixels are laid out in the horizontal and vertical directions to form a two-dimensional matrix, each of the pixels being configured to include m sub-pixels, and a plurality of observing-point disparity images being assigned for each of the sub-pixels to form a layout pattern determined in advance and displayed by carrying out a synthesizing process; and a parallax device which has a plurality of disparity separation sections associated with the sub-pixels, and which is used for separating the disparity images displayed on the image display device in a plurality of observing-point directions in order to make binocular vision of the disparity images possible.

### BACKGROUND

The present disclosure relates to a three-dimensional image display apparatus for displaying a three-dimensional image by making use of a parallax device such as a parallax barrier and relates to an image display device employed in the three-dimensional image display apparatus.

Technologies for displaying a three-dimensional image can be classified into a technology requiring the use of spectacles of the image observer and a technology allowing the image observer to observe an image three-dimensionally with the naked eyes by making use of no spectacles. An image display method based on the latter technology is referred to as a naked-eye three-dimensional image display method. Representatives of the naked-eye three-dimensional image display method include a parallax barrier method and a lenticular-lens method. In the case of the parallax barrier method and the lenticular-lens method, a plurality of disparity images for a binocular vision are spatially divided and displayed by synthesizing on an image display device such as a liquid-crystal display device and, then, the disparity images are subjected to a disparity separation process in the horizontal direction by making use of a parallax device serving as disparity separation means in order to implement the binocular vision. In the case of 2 observing points for example, the disparity images are a left-eye image and a right-eye image. In the case of the parallax barrier method in particular, as a parallax device, a parallax barrier provided with a split-shaped aperture is used. In the case of the lenticular-lens method, on the other hand, as a parallax device, a lenticular lens implemented by laying out a plurality of split lenses each having a cylindrical shape in parallel to each other is used.

### SUMMARY

In the case of a three-dimensional image display apparatus making use of the image display device and the parallax device like the ones described above, the pixel structure of the image display device and the structure of the parallax device are period structures different from each other. Thus, the three-dimensional image display apparatus raises a problem of generated luminance unevenness (moire).

As a method for solving this problem, Japanese Patent No. 4023626 proposes a method of reducing the luminance unevenness by increasing the aperture width of the parallax barrier to a value greater than a normal one. In accordance with this method, however, the amount of crosstalk is inevitably increased. On the top of that, depending on conditions, the amount of luminance unevenness cannot be reduced in some cases. In addition, Japanese Patent No. 3955002 proposes a method for decreasing the amount of luminance unevenness by making the parallax barrier inclined stripes. In accordance with this method, however, depending on conditions, the luminance unevenness cannot be completely eliminated in some cases. On the top of that, Japanese Patent No. 4271155 proposes a method for decreasing the amount of luminance unevenness secondarily by orienting the parallax barrier or the lenticular lens in a direction different from the normal direction. The phrase stating “decreasing the amount of luminance unevenness secondarily” implies that the amount of luminance unevenness is decreased as a second effect of a main effect which is an improvement of the vertical-horizontal ratio of the resolution. However, this method has a problem that this method cannot be applied under a condition of few observing points including pixel positions such as a condition of observing points the number of which is smaller than 16.

It is thus desirable to provide a three-dimensional image display apparatus capable of reducing the amount of luminance unevenness generated due to a difference in period structure between an image display device and a parallax barrier in order to improve the resolution of the three-dimensional image. In addition, it is desirable to provide the image display device proper for the three-dimensional image display apparatus.

A three-dimensional image display apparatus according to the present disclosure includes an image display device. In the image display device, a plurality of pixels are laid out in the horizontal and vertical directions to form a two-dimensional matrix; each of the pixels is configured to include m sub-pixels; and a plurality of observing-point disparity images are assigned for each of the sub-pixels to form a layout pattern determined in advance and displayed by carrying out a synthesizing process. The three-dimensional image display apparatus further includes a parallax device which has a plurality of disparity separation sections associated with the sub-pixels; and which is used for separating the disparity images displayed on the image display device in a plurality of observing-point directions in order to make binocular vision of the disparity images possible.

In addition, in the image display device, the layout pattern of the observing-point disparity images is subjected to a step placement process of making a shift in the vertical direction by a period equal to a multiple of n pixels and a shift in the horizontal direction by a period equal to 1 sub-pixel. On the top of that, the disparity separation sections employed in the parallax device are laid out in a direction satisfying the following condition expression:

arctan {β·n/(n−1)}−arctan β

where n is a multiple of m and β is the ratio of the vertical-direction pitch of the sub-pixel to the horizontal-direction pitch of the sub-pixel.

In addition, in the image display device according to the present disclosure: a plurality of pixels are laid out in the horizontal and vertical directions to form a two-dimensional matrix; each of the pixels is configured to include m sub-pixels; a plurality of observing-point disparity images are assigned for each of the sub-pixels to form a layout pattern determined in advance and displayed by carrying out a synthesizing process; and the layout pattern of the plural observing-point disparity images has been subjected to a step placement process of making a shift in the vertical direction by a period equal to a multiple of n pixels and a shift in the horizontal direction by a period equal to 1 sub-pixel.

In the three-dimensional image display apparatus according to an embodiment of the present disclosure, the layout pattern of the observing-point disparity images displayed on the image display device and the layout direction of the disparity separation sections employed in the parallax device are optimized so as to reduce the period of periodical luminance unevenness generated due to a difference in period structure between the image display device and the parallax device. In addition, in the image display device according to an embodiment of the present disclosure, the layout pattern of the disparity images is optimized into a pattern proper for the layout of the disparity images.

In accordance with the three-dimensional image display apparatus provided by an embodiment of the present disclosure, the layout pattern of the observing-point disparity images displayed on the image display device and the layout direction of the disparity separation sections employed in the parallax device are optimized under a condition determined in advance. Thus, it is possible to reduce the period of periodical luminance unevenness generated due to a difference in period structure between the image display device and the parallax device. As a result, the resolution of the three-dimensional image can be improved. In addition, in accordance with the image display device provided by an embodiment of the present disclosure, it is possible to present a display optimum for such a layout of the disparity separation sections.

### BRIEF DESCRIPTION OF THE DRAWINGS

FIG. 1 is a cross-sectional diagram showing a typical overall configuration of an image display device according to an embodiment of the present disclosure and a three-dimensional image display apparatus employing the image display device;

FIG. 2 is a top-view diagram showing a first typical configuration optimizing a layout pattern of disparity images and a layout direction of apertures each functioning as a disparity separation section of a parallax device under a condition determined in advance in the three-dimensional image display apparatus shown in FIG. 1;

FIG. 3 is a top-view diagram showing a second typical configuration optimizing a layout pattern of disparity images and a layout direction of apertures each functioning as a disparity separation section of a parallax device under a condition determined in advance in the three-dimensional image display apparatus shown in FIG. 1;

FIG. 4 is an explanatory diagram showing the configuration of the existing pixel array and the existing parallax device including apertures each having a step shape;

FIG. 5 is an explanatory diagram showing the configuration of the existing pixel array and the existing parallax device including apertures each having an inclined stripe shape;

FIG. 6 is an explanatory diagram to be referred to in description of the principle of generation of periodical luminance unevenness due to two different period structures;

FIG. 7 is an explanatory diagram to be referred to in description of a process to geometrically find the period of periodical luminance unevenness;

FIG. 8 is a characteristic diagram showing results of a process to compute the period of periodical luminance unevenness for an angular slip of a period structure;

FIG. 9 is an explanatory diagram showing a typical configuration in which the layout pattern of disparity images is not shifted;

FIG. 10 is an explanatory diagram showing a typical pattern obtained as a result of a shifting and arranging process carried out on disparity images;

FIG. 11 is a characteristic diagram showing relations between the shift period and angular slip;

FIG. 12 is a top-view diagram showing a typical configuration in which each aperture of a parallax barrier in the three-dimensional image display apparatus shown in FIG. 1 has an inclined strip shape;

FIG. 13 is a cross-sectional diagram showing a typical configuration in which a lenticular lens is used as a parallax barrier in the three-dimensional image display apparatus shown in FIG. 1; and

FIG. 14 is a top-view diagram showing a typical configuration in which a lenticular lens is used as a parallax barrier.

### DETAILED DESCRIPTION OF THE PREFERRED EMBODIMENT

An embodiment of the present disclosure is explained in detail by referring to the diagrams as follows.

### [Overall Configuration of the Three-Dimensional Image Display Apparatus]

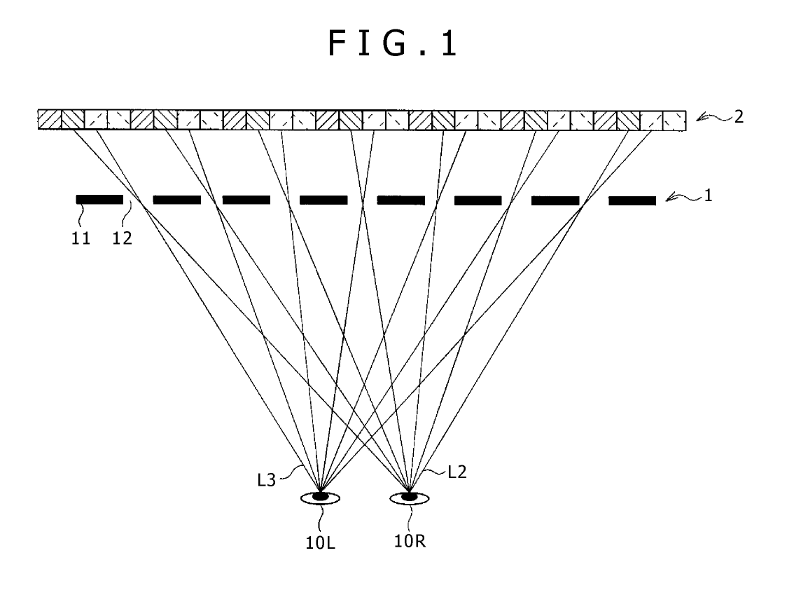

FIG. 1 is a cross-sectional diagram showing a typical configuration of an image display device 2 according to an embodiment of the present disclosure and a three-dimensional image display apparatus employing the image display device 2. As shown in the figure, the three-dimensional image display apparatus includes the image display device 2 and a parallax barrier 1 serving as a parallax device. The parallax barrier 1 has shielding sections 11 and apertures 12.

The image display device 2 is configured as a two-dimensional image display unit such as a liquid-crystal display panel, a display panel adopting an electric luminance method or a plasma display panel. On a display screen of the image display device 2, a plurality of pixels are laid out in the horizontal and vertical directions to form a two-dimensional matrix. Each of the pixels is configured to include m sub-pixels where m is an integer equal to or greater than 1. For example, every pixel is configured to include R (red color), G (green color) and B (blue color) sub-pixels laid out alternately in the horizontal direction. In the vertical direction, sub-pixels of the same colors are laid out. On the image display device 2, a plurality of disparity images for the same plurality of observing points are assigned for each of the sub-pixels to form a predetermined layout pattern and displayed by carrying out a synthesizing process.

The parallax barrier 1 is a section for separating a plurality of disparity images, which are included in the disparity synthesized image displayed on the image display device 2, in the direction of a plurality of observing points so that the binocular vision of the disparity images is possible. The parallax barrier 1 is placed to face the image display device 2 in such a positional relation making the binocular vision possible. As described above, the parallax barrier 1 has shielding sections 11 and apertures 12. Each of the shielding sections 11 is a shielding section for blocking light. On the other hand, each of the apertures 12 is a disparity separation section used for passing light and associated with one of the sub-pixels on the image display device 2 under a predetermined condition so as to make the binocular vision possible. The parallax barrier 1 is created by providing the shielding sections 11 on a transparent planar plate. Each of the shielding sections 11 is a black substance passing no light or a thin metal or the like. The thin metal or the like is used for reflecting light.

The parallax barrier 1 separates a plurality of disparity images, which are included in the disparity synthesized image displayed on the image display device 2, so that only specific disparity images are observed when the image display device 2 is observed from the position of a specific observing point. From the relation between the positions of the apertures 12 of the parallax barrier 1 and the sub-pixels of the image display device 2, the emission angle of light emitted from the sub-pixels of the image display device 2 is restricted. The sub-pixels of the image display device 2 have different display directions due to the relation between the positions of the apertures 12 of the parallax barrier 1 and the sub-pixels of the image display device 2. Light beams L3 and light beams L2 emitted by different sub-pixels arrive respectively at a left eye 10L of the observer and a right eye 10R of the observer. The state of observing images having disparities different from each other allows a three-dimensional image to be perceived.

Every aperture 12 of the parallax barrier 1 is provided as an aperture having a step shape oriented typically in an inclined direction. However, every aperture 12 can also be provided as an aperture having a stripe shape oriented in an inclined direction. On the image display device 2, a plurality of disparity images for the same plurality of observing points are displayed by carrying out a synthesizing process to form a predetermined layout pattern according to a barrier pattern. In the case of a barrier pattern having a step shape, the plural parity images are divided into a step shape to form a predetermined layout pattern in an inclined direction in accordance with this barrier pattern before being synthesized.

### [Typical Layout Pattern of the Parity Image and Typical Layout Direction of the Apertures 12 of the Parallax Barrier 1]

In the parallax barrier 1 of this three-dimensional image display apparatus, the layout pattern of a plurality of disparity images for the same plurality of observing points is a pattern subjected to a step placement process for shifting in the vertical direction by a period equal to a multiple of the size of n pixels and in the horizontal direction by a distance equal to the size of 1 sub-pixel. In addition, the apertures 12 each serving as a disparity separation section in the parallax barrier 1 serving as a parallax device are laid out in a direction satisfying the following condition expression:

arctan {β·n/(n−1)}−arctan β

In the above expression, n is a multiple of m, and β is the ratio of the vertical-direction pitch of the sub-pixel to the horizontal-direction pitch of the sub-pixel.

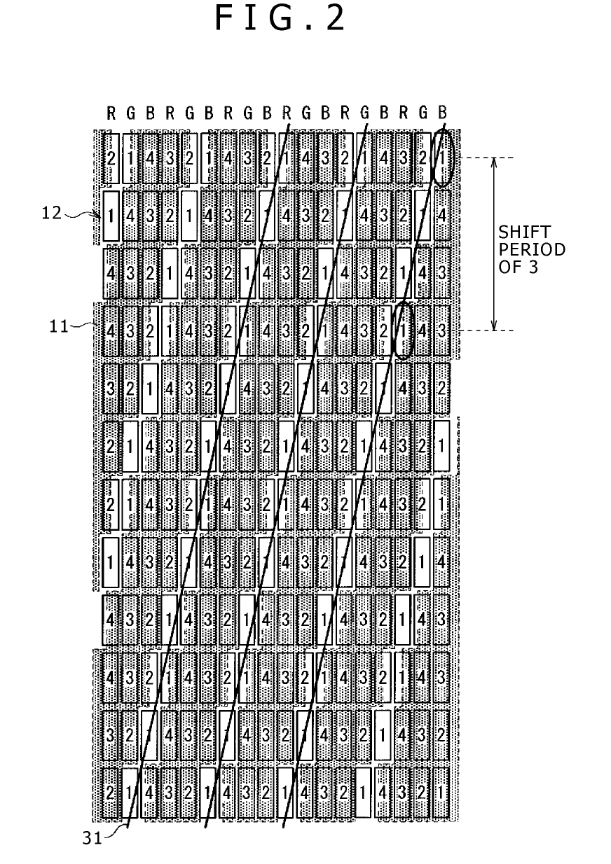

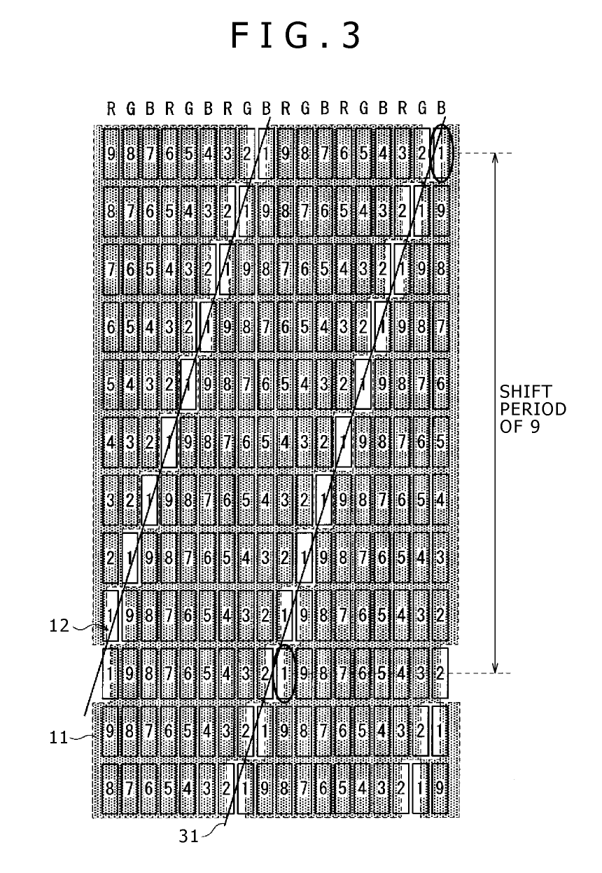

FIGS. 2 and 3 are diagrams each showing a typical configuration optimizing the layout pattern of disparity images and the layout direction of the apertures 12 each serving as a disparity separation section in the parallax device under the condition given above. In the typical configurations shown in FIGS. 2 and 3, every pixel is configured to include m (=3) sub-pixels which are R, G and B sub-pixels. In the typical configurations shown in FIGS. 2 and 3, each fine portion having a rectangular shape is one sub-pixel. A number assigned to a sub-pixel and shown inside the sub-pixel is the number of an observing point (or a disparity). FIG. 2 is a diagram showing a typical configuration of a display for four observing points (disparities). A number of one of the four observing points (disparities) is assigned to a sub-pixel. The number of one of the four observing points (disparities) is a number in the range 1 to 4. In the typical configuration shown in FIG. 2, the layout pattern of the disparity images for a plurality of observing points has been subjected to a step placement operation for shifting in the vertical direction at a period of three pixels (at a shift period of 3) and in the horizontal direction by a distance of one sub-pixel. FIG. 3 is a diagram showing a typical configuration of a display for nine observing points (disparities). A number of one of the nine observing points (disparities) is assigned to a sub-pixel. The number of one of the nine observing points (disparities) is a number in the range 1 to 9. In the typical configuration shown in FIG. 3, the layout pattern of the disparity images for a plurality of observing points has been subjected to a step placement operation for shifting in the vertical direction at a period of nine pixels (at a shift period of 9) and in the horizontal direction by a distance of one sub-pixel.

In addition, in the case of the typical configurations shown in FIGS. 2 and 3, for m=3, under the condition given above, the apertures 12 in the parallax barrier 1 are laid out in an aperture direction 31 satisfying the following conditional expression:

arctan {3n/(n−1)}−arctan 3

In the above expression, n is a multiple of 3.

By virtue of the configurations shown in FIGS. 2 and 3, it is possible to reduce the amount of luminance unevenness (moire) generated due to a difference in period structure between the image display device 2 and the parallax barrier 1. As a result, it is possible to improve the resolution of the three-dimensional image.

The principle of reduction of the amount of luminance unevenness is described as follows.

### [Luminance-Unevenness Generation and Reduction Principles]

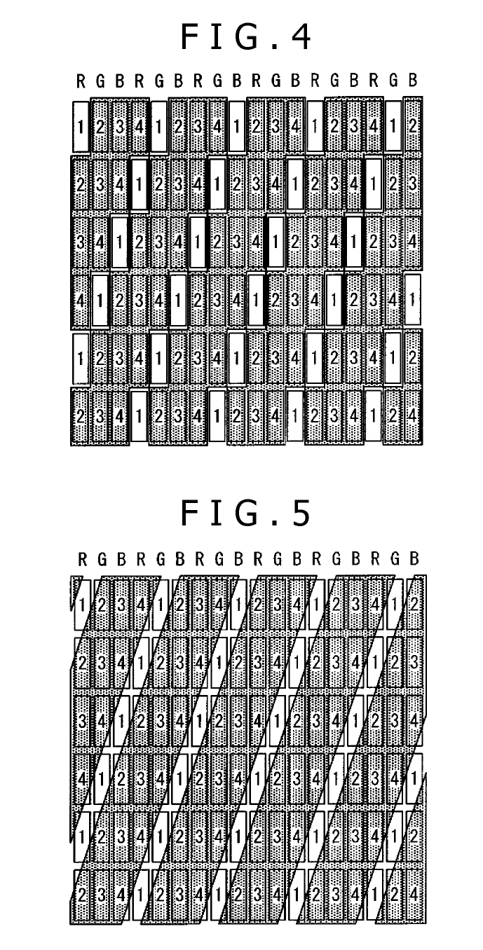

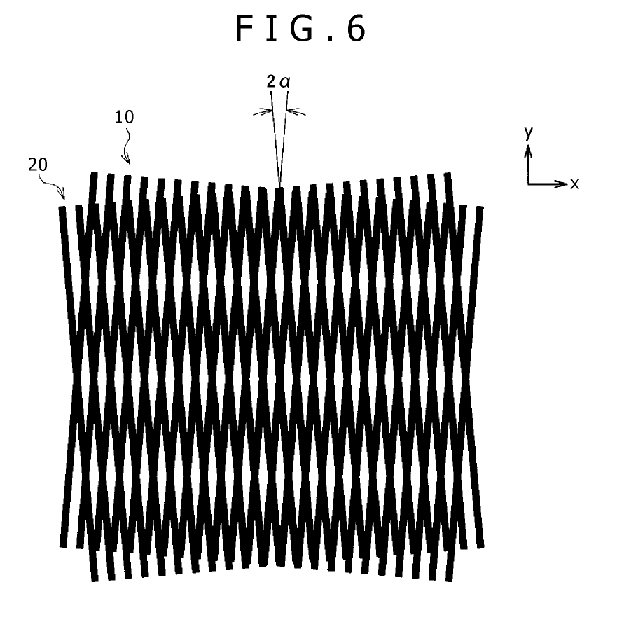

In order to explain the principle of reduction of the amount of periodical luminance unevenness, first of all, the following description briefly explains the principle of generation of periodical luminance unevenness raising a problem in the three-dimensional image display apparatus. FIGS. 4 and 5 are diagrams showing a parallax barrier configured in accordance with the existing parallax barrier method and a configuration optimizing pixel mapping (the layout pattern of a plurality of disparity images for a plurality of observing points) in accordance with the existing parallax barrier method. It is to be noted that FIG. 4 is a diagram showing a configuration for a step barrier method whereas FIG. 5 is a diagram showing a configuration for an inclined stripe barrier method. As is obvious from the figures, the specific observing-point display pixels (strictly speaking, sub-pixels) are laid out to form a step shape in a direction matching the aperture direction of the parallax barrier. It is to be noted that FIGS. 4 and 5 show a state described as follows. In this state, disparity images to which observing-point numbers are assigned are visible. The observing-point numbers start with an observing-point number of 1 assigned to a disparity image at a specific observing-point position.

Since a sub-pixel is used as it is as a sub-pixel of an observing-point display pixel, the layout direction of the specific observing-point display pixels and the aperture direction of the parallax barrier are expressed as follows:

Layout direction of specific observing-point display pixels=Aperture direction of parallax barrier=arctan β

In the above expression, a quantity β is expressed as follows:

β=py/px

In the above equation, a quantity py is the sub-pixel pitch in the vertical direction whereas a quantity px is the sub-pixel pitch in the horizontal direction.

In an ordinary liquid-crystal display unit or the like, R, G and B sub-pixels laid out in the horizontal direction are used. Thus, the ratio of the sub-pixel pitch in the vertical direction to the sub-pixel pitch in the horizontal direction is 1:3. Accordingly, the layout direction of the specific observing-point display pixels and the aperture direction of the parallax barrier are expressed as follows:

Layout direction of specific observing-point display pixels=Aperture direction of parallax barrier=arctan 3

In addition, in recent years, R, G, B and W (white) sub-pixels laid out in the horizontal direction as well as R, G, B and Y (yellow) sub-pixels laid out in the horizontal direction are each being introduced as a set including four colored sub-pixels. In this case, the layout direction of the specific observing-point display pixels and the aperture direction of the parallax barrier are expressed as follows:

Layout direction of specific observing-point display pixels=Aperture direction of parallax barrier=arctan 4

The directions described above are directions for a case in which the vertical-direction pitch of a single pixel composed of sub-pixels is equal to the horizontal-direction pitch of a single pixel composed of sub-pixels. However, the directions described above are not directions for a case in which the vertical-direction pitch of a single pixel is not equal to the horizontal-direction pitch of a single pixel. Even for a case in which a lenticular lens is used as the parallax device, the cylindrical bus-line direction is the same.

If attention is focused on the image display device and the parallax device at a low-order frequency, each of the devices can be regarded as a one-dimensional period structure regarding the transmittance (or the optical intensity) having a period at the angle described above. The one-dimensional period structure is expressed by the Fourier series as follows:

$${f}_{1} ( x , y ) = {a}_{1} + {\sum }_{n = 1}^{∞} {b}_{1 n} \cdot cos [ n {φ}_{1} ( x , y ) ] \\ {f}_{2} ( x , y ) = {a}_{2} + {\sum }_{m = 1}^{∞} {b}_{2 n} \cdot cos [ m {φ}_{2} ( x , y ) ] \qquad ( 1 )$$

In the above equations, notation f₁ denotes a function expressing the periodical optical intensity of the image display device (or the parallax device) whereas notation a denotes a Fourier coefficient determining the shape of the periodical optical intensity. Notation f₂ denotes a function expressing the periodical optical intensity of the parallax device (or the image display device) whereas notation b denotes a Fourier coefficient determining the shape of the periodical optical intensity. Notations n and m each denote the order of the Fourier series. Notation φ denotes a function expressing a basic two-dimensional distribution of each of the period structures.

A display unit that can be observed by the observer as a three-dimensional display unit is a display unit superposing the two periodical optical intensities on each other, and the superposition of the two periodical optical intensities is a product of two functions expressing the two periodical optical intensities. Thus, the superposition of the two periodical optical intensities can be expressed as follows.

$${f}_{1} ( x , y ) {f}_{2} ( x , y ) = {a}_{1} {a}_{2} + {a}_{1} {\sum }_{m = 1}^{∞} {b}_{2 m} cos [ m {φ}_{2} ( x , y ) ] + {a}_{2} {\sum }_{n = 1}^{∞} {b}_{1 m} cos [ n {φ}_{1} ( x , y ) ] + {\sum }_{m = 1}^{∞} {\sum }_{n = 1}^{∞} {b}_{1 n} {b}_{2 m} cos [ n {φ}_{1} ( x , y ) ] cos [ m {φ}_{2} ( x , y ) ] \qquad ( 2 )$$

Term 4 serving as the fourth term of the expression on the right-hand side of Eq. (2) can be expressed as follows.

$$Term 4 = \frac{1}{2} {b}_{11} {b}_{21} cos [ {φ}_{1} ( x , y ) - {φ}_{2} ( x , y ) ] + \frac{1}{2} {\sum }_{m = 1}^{∞} {\sum }_{n = 1}^{∞} {b}_{1 n} {b}_{2 m} cos [ n {φ}_{1} ( x , y ) - m {φ}_{2} ( x , y ) ] + \frac{1}{2} {\sum }_{m = 1}^{∞} {\sum }_{n = 1}^{∞} {b}_{1 n} {b}_{2 m} cos [ n {φ}_{1} ( x , y ) + m {φ}_{2} ( x , y ) ] \qquad ( 3 )$$

The first term of the expression on the right-hand side of Eq. (3) represents the most basic periodical luminance unevenness. That is to say, the basic shape of the periodical luminance unevenness is expressed as follows:

(Basic shape of periodical luminance unevenness)=(½)b₁₁b₂₁ cos [φ₁(x,y)−φ₂(x,y)] (4)

In order to derive an equation for the angular slip of the period structure, functions expressing basic two-dimensional distributions of the period structures are defined as follows:

φ₁(x,y)=(2π/λ₁)(x cos α+y sin α)

φ₂(x,y)=(2π/λ₂)(x cos α−y sin α) (5)

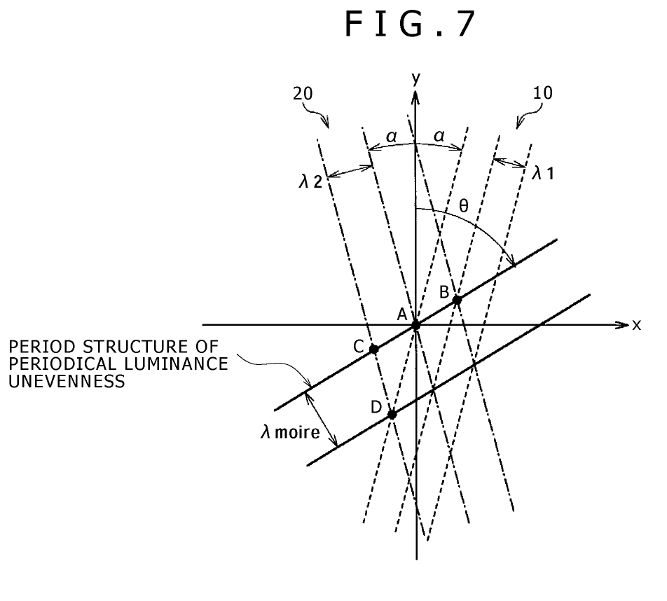

The reader is advised to refer to FIGS. 6 and 7.

In the above equations, as shown in FIGS. 6 and 7, notation λ₁ denotes the pitch of a first period structure 10 whereas notation λ₂ denotes the pitch of a second period structure 20. 2α is the angular slip quantity between the first period structure 10 and the second period structure 20. By geometrically expressing the angular slip quantity of the first period structure 10 and the second period structure 20 as shown in FIG. 7, the period of the periodical luminance unevenness can be found.

A distance AB can be expressed by making use of the period of the period structures as follows:

(Distance AB)=λ₁/sin(θ−α)=λ₂/sin(θ+α) (6)

In the above equation, notation θ denotes the direction of the periodical luminance unevenness. The direction θ of the periodical luminance unevenness is expressed as follows.

tan θ=tan {(λ₁+λ₂)/(λ₂−λ₁)} (7)

From FIG. 7, by making use of a pitch λₘₒᵢᵣₑ of the periodical luminance unevenness, a distance CD can be expressed as follows:

(Distance CD)=λ₁/sin 2α=λₘₒᵢᵣₑ/sin(θ+α) (8)

From the equation (8), the pitch λₘₒᵢᵣₑ of the periodical luminance unevenness can be expressed as follows:

(Pitch λₘₒᵢᵣₑ of periodical luminance unevenness)=λ₁[sin(θ+α)/sin 2α] (9)

By making use of Eq. (7), the expression of the pitch λₘₒᵢᵣₑ of the periodical luminance unevenness can be changed to the following expression:

$${λ}_{moire} = \frac{{λ}_{1} {λ}_{2}}{\sqrt{{λ}_{2}^{2} {sin}^{2} 2 α + {( {λ}_{2} cos 2 α - {λ}_{1} )}^{2}}} \qquad ( 10 )$$

In an ordinary three-dimensional image display unit, as many observing-point display pixels as display observing points are laid out in the horizontal direction. Thus, the relation between the aperture pitch of the parallax device and the sub-pixel pitch of the image display device is expressed as follows:

p2=N·p1 (11)

In the above equation, notation p1 denotes the sub-pixel pitch of the image display device (or the aperture pitch of the parallax device) whereas notation p2 denotes the aperture pitch of the parallax device (or the sub-pixel pitch of the image display device) and notation N denotes the number of observing points.

As is obvious from Eq. (4), however, the value of λ₁ must approximately match the value of λ₂. In addition, the Nth order of the high-frequency component of p1 corresponds to λ₁ whereas the Nth order of the high frequency component of p2 corresponds to λ₂. Thus,

λ₂=λ₁

Accordingly, Eq. (10) can be rewritten into the following equation:

$${λ}_{moire} = \frac{{λ}_{1}}{\sqrt{{sin}^{2} 2 α + {( cos 2 α - 1 )}^{2}}} \qquad ( 12 )$$

If the pitch λₘₒᵢᵣₑ of the periodical luminance unevenness is normalized by the sub-pixel pitch λ₁ of the image display device, Eq. (12) can be rewritten into the following equation:

$${λ}_{moire} = \frac{1}{\sqrt{{sin}^{2} 2 α + {( cos 2 α - 1 )}^{2}}} \qquad ( 13 )$$

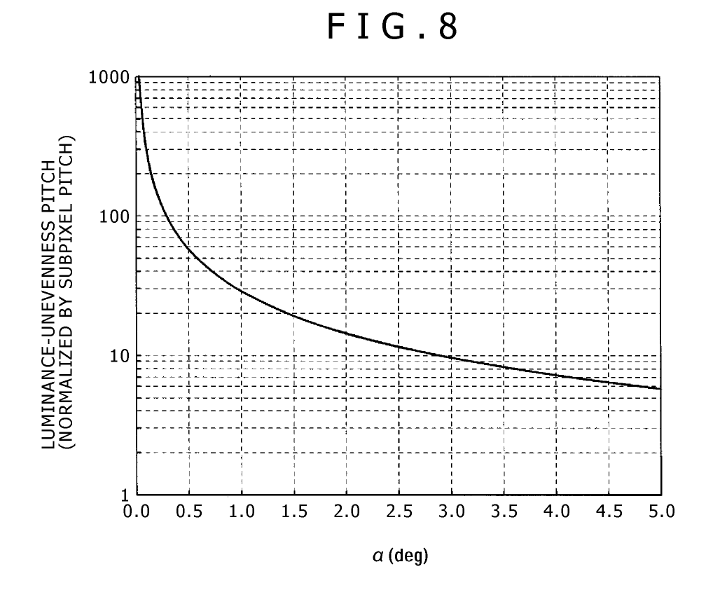

FIG. 8 is a diagram shows results of computation making use of Eq. (13) for each observing-point count. As is obvious from FIG. 8, if the angle α exceeds three degrees, it is known that the pitch of the luminance unevenness becomes smaller than the sub-pixel pitch of the image display device by ten times (3.33 times the ordinary pixel).

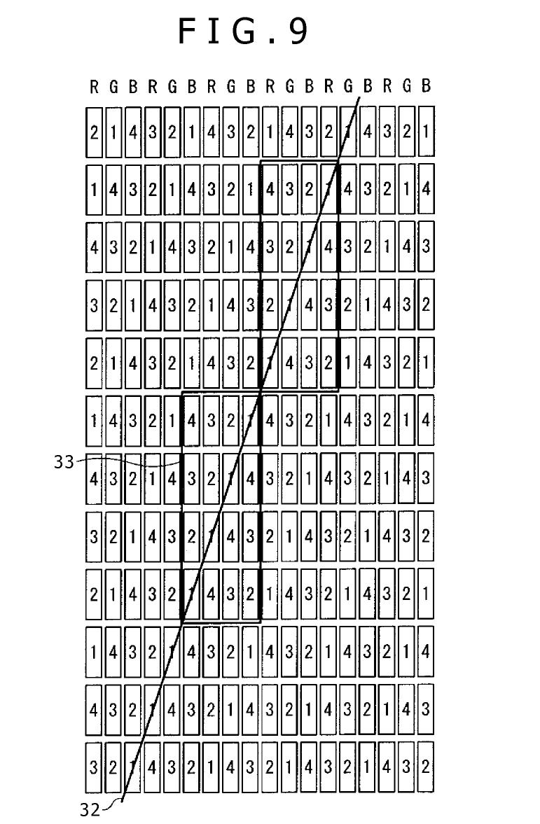

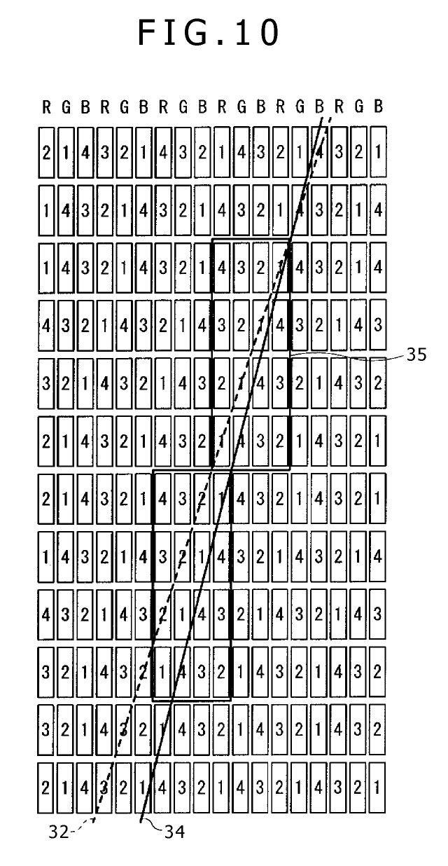

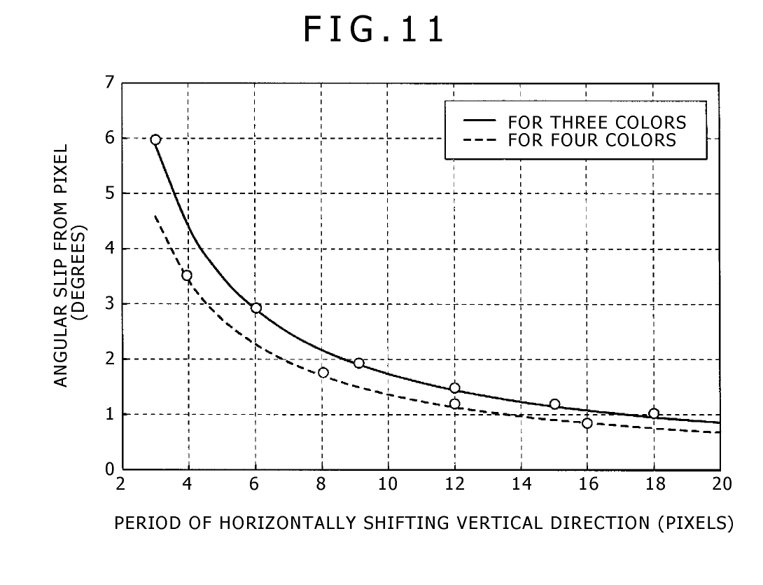

For example, as shown in FIG. 10, from a state shown in FIG. 9, the pixel layout is shifted in the vertical direction by any arbitrary observing-point image display period and in the horizontal direction by 1 sub-pixel. The arbitrary observing-point image display period is a period of 3 or more pixels. In the case of the typical pattern shown in FIG. 10, the arbitrary observing-point image display period is a period of 4 pixels. An aperture direction 34 of the parallax device is adjusted to the shifted pixel layout. In the case of a lenticular lens, the aperture direction 34 is the cylindrical bus-line direction. It is to be noted that, in the case of the typical example shown in FIG. 9, images at observing points are allocated to sub-pixels without shifting pixels in a specific direction 32 (that is, the aperture direction 32). Reference numerals 34 and 35 each denote a typical pixel group determining the shift period.

In this case, the angular slip between the direction of the image display device and the direction of the parallax device is expressed by the following expression:

arctan {β·n/(n−1)}−arctan β (14)

Notation n used in the above expression denotes the vertical-direction pixel period for shifting in the vertical direction.

In a three-dimensional display operation, in order to allocate sub-pixels to all pixels so as to lay out sub-pixels in the vertical direction, it is necessary to have the following equation hold true:

(Shift period n)=(Multiple of m)

Notation m used in the above equations denotes the number of sub-pixels composing a single pixel or the number of colors making up the pixel.

In the case of an image display device composed of R, G and B sub-pixels, expression (14) can be rewritten into the following expression:

arctan {3n/(n−1)}−arctan 3 (15)

The value of expression (15) is shown in FIG. 11. In a three-dimensional display operation, however, in order to allocate R, G and B sub-pixels to all pixels so as to lay out the R, G and B sub-pixels in the vertical direction, it is necessary to have the following equation hold true:

(Shift period n)=(Multiple of 3) (16)

(Represented by circles on a solid curve shown in FIG. 11)

By the same token, in the case of an image display device composed of sub-pixels having four different colors, expression (15) can be rewritten into the following expression:

arctan {4n/(n−1)} arctan 4 (17)

In a three-dimensional display operation, however, in order to allocate sub-pixels having four different colors to all pixels so as to lay out the sub-pixels having the four different colors in the vertical direction, it is necessary to have the following equation hold true:

(Shift period n)=(Multiple of 4) (18)

By laying out the image display device and laying out the parallax device as explained before, the period of the periodical luminance unevenness can be reduced substantially. As a result, the periodical luminance unevenness can be made almost not striking. In addition, unlike the technology disclosed in Japanese Patent No. 4271155, the direction of the parallax device can be selected with a certain degree of freedom independently of the number of observing points.

As described above, FIGS. 2 and 3 each show a typical configuration satisfying an equation expressing the angular slip in terms of expression (15). As is obvious from the typical configurations shown FIGS. 2 and 3, a pixel not naturally desired as a visible pixel is slightly visible in a phenomenon known as crosstalk. In a desirable state of the typical configurations shown FIGS. 2 and 3, only disparity images to which observing-point numbers are assigned are visible. However, disparity images to which other observing-point numbers are assigned are also visible. In actuality, however, the devices of the configurations shown in FIGS. 2 and 3 are manufactured and results of verification of the devices indicate that deteriorations of images on three-dimensional displays are not verified at all.

### MODIFICATIONS

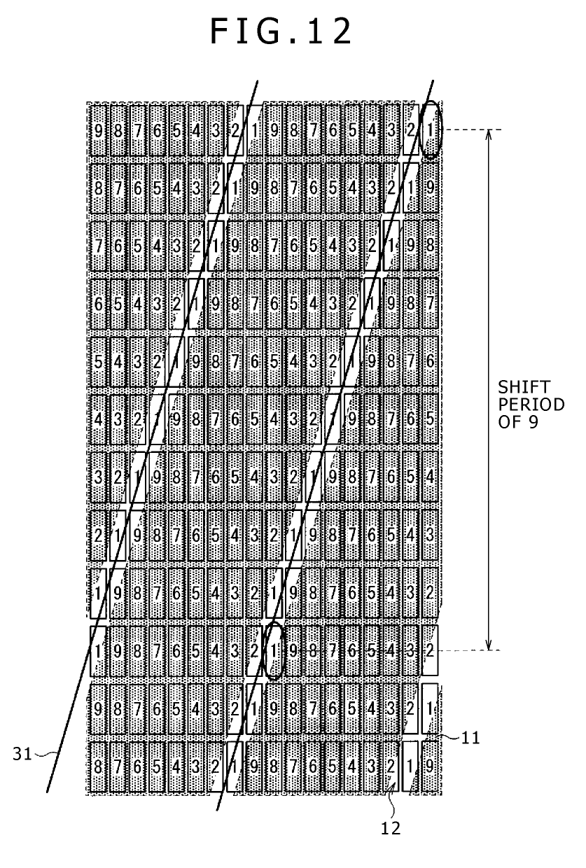

FIGS. 2 and 3 each show a typical configuration in which the aperture 12 has a step shape. As shown in FIG. 12 for example, however, the aperture 12 can also be created as an aperture section having an inclined stripe shape. In the configuration shown in FIG. 12, the display is a typical display for nine observing points (disparities) as is the case with the configuration shown in FIG. 3. In this case, a number in the range 1 to 9 is assigned to a sub-pixel. The numbers assigned to sub-pixels are numbers 1 to 9 corresponding to nine observing points (or nine disparities) respectively. In addition, the layout pattern of disparity images for a plurality of observing points is subjected to a step placement process (with a shift period of 9) for shifting in the vertical direction by a period of nine pixels and in the horizontal direction by one sub-pixel.

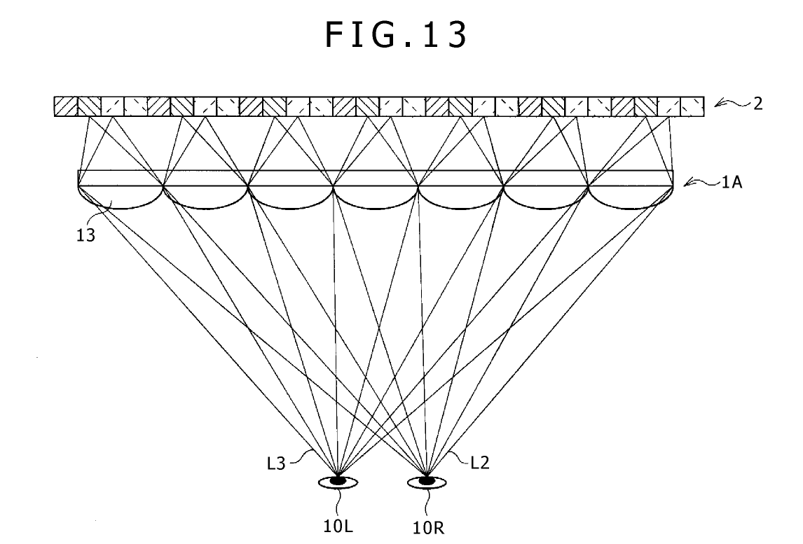

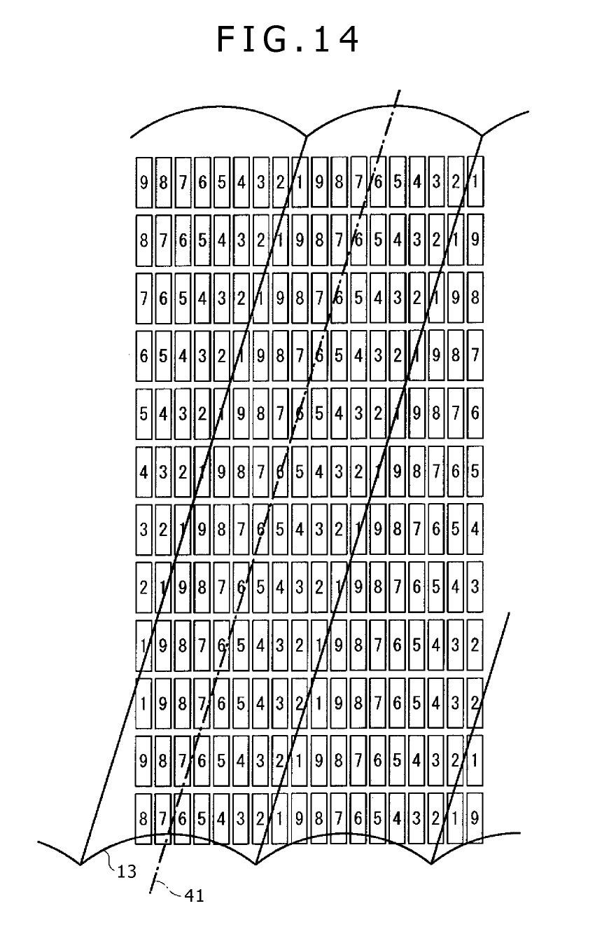

In addition, as shown in FIG. 13, in place of the parallax barrier 1 shown in FIG. 1, a lenticular lens 1A can also be used as a parallax device. The lenticular lens 1A has a plurality of split lenses functioning as a plurality of disparity separation sections. Each split lens is a cylindrical lens 13 extended in a direction determined in advance. In this case, as shown in FIG. 14, it is only necessary to have a configuration in which the cylindrical bus-line direction 41 of the cylindrical lens 13 satisfies a condition determined in advance.

The present application contains subject matter related to that disclosed in Japanese Priority Patent Application JP 2010-203474 filed in the Japan Patent Office on Sep. 10, 2010, the entire content of which is hereby incorporated by reference.

It should be understood by those skilled in the art that various modifications, combinations, sub-combinations and alterations may occur depending on design requirements and other factor in so far as they are within the scope of the appended claims or the equivalents thereof.

What is claimed is:

1. A three-dimensional image display apparatus comprising:
an image display device having
a plurality of pixels laid out in the horizontal and vertical directions to form a two-dimensional matrix, each of said pixels being configured to include m sub-pixels, and a plurality of observing-point disparity images being assigned for each of said sub-pixels to form a layout pattern determined in advance and displayed by carrying out a synthesizing process; and
a parallax device which
has a plurality of disparity separation sections associated with said sub-pixels, and
is used for separating said disparity images displayed on said image display device in a plurality of observing-point directions in order to make binocular vision of said disparity images possible,
wherein the layout pattern of said observing-point disparity images in said image display device is subjected to a step placement process of making a shift in said vertical direction by a period equal to a multiple of n pixels and a shift in said horizontal direction by a period equal to 1 sub-pixel; and
said disparity separation sections employed in said parallax device are laid out in a direction satisfying the following condition expression
arctan {β·n/(n−1)}−arctan β,
where n is a multiple of m and β is the ratio of the vertical-direction pitch of said sub-pixel to the horizontal-direction pitch of said sub-pixel.

2. The three-dimensional image display apparatus according to claim 1, wherein
each of said pixels employed in said image display device has m sub-pixels, where m=3;
the layout pattern of said observing-point disparity images in said image display device is subjected to a step placement process of making a shift in said vertical direction by a period equal to a multiple of n pixels, where n=3, and a shift in said horizontal direction by a period equal to 1 sub-pixel; and
said disparity separation sections employed in said parallax device are laid out in a direction satisfying the following condition expression:
arctan {3n/(n−1)}−arctan 3,
where n is a multiple of 3.

3. The three-dimensional image display apparatus according to claim 1, wherein
each of said pixels employed in said image display device has m sub-pixels, where m=4;
the layout pattern of said observing-point disparity images in said image display device is subjected to a step placement process of making a shift in said vertical direction by a period equal to a multiple of n pixels, where n=4, and a shift in said horizontal direction by a period equal to 1 sub-pixel; and
said disparity separation sections employed in said parallax device are laid out in a direction satisfying the following condition expression:
arctan {4n/(n−1)}−arctan 4,
where n is a multiple of 4.

4. The three-dimensional image according to claim 1, wherein
said parallax device is a parallax barrier having a plurality of apertures functioning as said disparity separation sections for transmitting light and a shielding section for blocking light; and
said apertures each have a step shape or an inclined stripe shape and the aperture direction of said apertures satisfies said condition expression.

5. The three-dimensional image according to claim 1, wherein
said parallax device is a lenticular lens having a plurality of split lenses functioning as said disparity separation sections; and
each of said split lenses is a cylindrical lens extended in a direction determined in advance.

6. The three-dimensional image according to claim 1, wherein said sub-pixels having the same color are laid out in the vertical direction in said image display apparatus and said sub-pixels having m different colors are laid out periodically and alternately in the horizontal direction in said image display apparatus.

7. An image display device, wherein
a plurality of pixels are laid out in the horizontal and vertical directions to form a two-dimensional matrix;
each of said pixels is configured to include m sub-pixels;
a plurality of observing-point disparity images are assigned for each of said sub-pixels to form a layout pattern determined in advance and displayed by carrying out a synthesizing process; and
the layout pattern of said plural observing-point disparity images is subjected to a step placement process of making a shift in said vertical direction by a period equal to a multiple of n pixels and a shift in said horizontal direction by a period equal to one sub-pixel.
